(19) United States
(12) Patent Application Publication
(10) Pub. No.: US 2003/0079891 A1
(43) Pub. Date: May 1, 2003

(54) Ground penetrating tool

(76) Inventor: Glenn Layton JR., Wellsville, KS (US)

Correspondence Address: HARSHAW RESEARCH INCORPORATED, P O BOX 418, OTTAWA, KS, 66067, US

(21) Appl. No.: 10/032,627

(22) Filed: Oct. 26, 2001

(51) Int. Cl. B25D 17/00

(52) U.S. Cl. 173/30

(57) ABSTRACT

A ground penetrating tool includes an elongate rod having a pointed first end and a second end. A striker plate is attached to the rod and displaced from the second end and a stop is attached to the second end. A hammer sleeve is coupled to the rod for slidable movement therealong between the striker plate and stop. The pointed end of the rod is urged into or out of a ground surface as the hammer sleeve is selectively impacted against the striker plate or stop, respectively, by a user. At least one pivotal footrest is coupled to the rod at a selectable position therealong such that the pointed end may be urged into a ground surface with foot pressure.

### BACKGROUND OF THE INVENTION

This invention relates generally to ground penetrating tools and, more particularly, to a ground penetrating tool having hammer sleeve and footrest means for making holes in the ground suitable for mounting signage therein.

Marker posts and poles with signage attached thereto are typically driven into a ground surface using a sledgehammer or similar means. And, real estate signs are typically placed in the yards of homes that are for sale. However, real estate signs may not be sufficiently robust to endure the harsh mounting methods that are typical for other signage. In addition, a real estate agent may not have the appropriate tools, expertise, or physical wherewithal to mount real estate signs into hard ground surfaces.

Various devices have been proposed in the art for impacting a ground or work surface. Although assumably effective for their intended purposes, the existing devices do not enable a person standing upright to bore a hole in the ground suitable for mounting a sign post therein.

Therefore, it is desirable to have a ground penetrating tool that can penetrate the ground when a user operates a hammer sleeve. Further, it is desirable to have a tool that can penetrate the ground when a user applies foot pressure upon a pair of height adjustable footrests. In addition, it is desirable to have a ground penetrating tool that is portable and can be easily assembled/disassembled.

### SUMMARY OF THE INVENTION

A ground penetrating tool according to the present invention includes an elongate rod having a first rod portion releasably connected to a second rod portion. The first rod portion includes a pointed first end and an opposed open second end. The first end of the first rod portion is adapted to be driven into a ground surface and removed therefrom so that a sign post, such as for a real estate sign, may be mounted in the hole. The second rod portion includes a first end configured to be threadably coupled to the second end of the first rod portion. A striker plate is fixedly attached to the first rod portion and is displaced slightly from the second end thereof. A stop plate is fixedly attached to the second end of the second rod portion. The ground penetrating tool includes a hammer sleeve adapted to move slidably along the first and second rod portions between the striker and stop plates when the rod portions are coupled together for driving the first end of the first rod portion into the ground or removing it therefrom, respectively. A pair of footrests are releasably coupled to the first rod portion for enabling a user to urge the first end of the first rod portion into the ground. The footrests are height adjustable for the user's convenience.

Therefore, a general object of this invention is to provide a ground penetration tool useful for making a hole in the ground suitable for mounting a sign post therein.

Another object of this invention is to provide a ground penetrating tool, as aforesaid, which can be utilized by a user standing in a completely upright position.

Still another object of this invention is to provide a ground penetrating tool, as aforesaid, that is safe, durable, and inexpensive to manufacturer.

Yet another object of this invention is to provide a ground penetrating tool, as aforesaid, having a hammer sleeve which may be reciprocated to urge a pointed end of the tool into the ground.

A further object of this invention is to provide a ground penetrating tool, as aforesaid, having a footrest which may be pressured by a user's foot so as to urge the end of the tool into the ground.

Other objects and advantages of this invention will become apparent from the following description taken in connection with the accompanying drawings, wherein is set forth by way of illustration and example, an embodiment of this invention.

### BRIEF DESCRIPTION OF THE DRAWINGS

FIG. 1 is a perspective view of a ground penetrating tool according to a preferred embodiment of the present invention with the footrests in a retracted configuration;

FIG. 2 is a front view of the tool as in FIG. 1 with the footrests in a use configuration;

FIG. 3 is an isolated exploded view on an enlarged scale of the footrest assembly as in FIG. 1;

FIG. 4 is an isolated exploded view on an enlarged scale of the hammer sleeve assembly as in FIG. 1; and

FIG. 5 is an isolated view of a handle assembly according to another embodiment of the present invention.

### DESCRIPTION OF THE PREFERRED EMBODIMENT

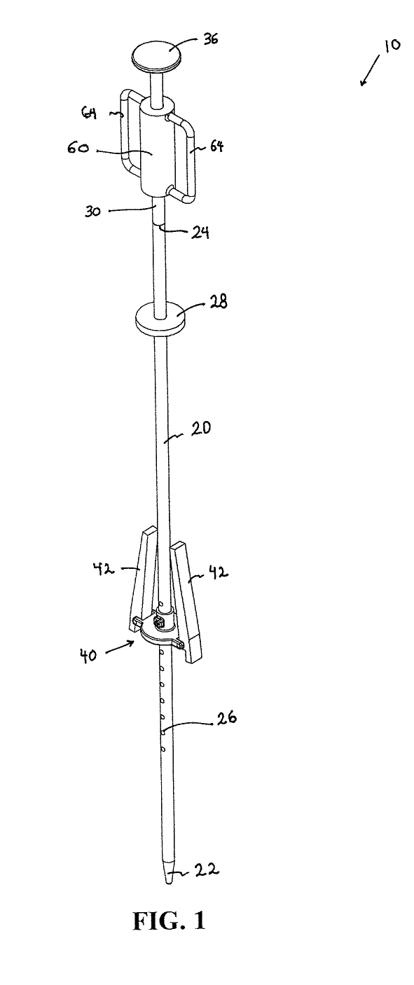

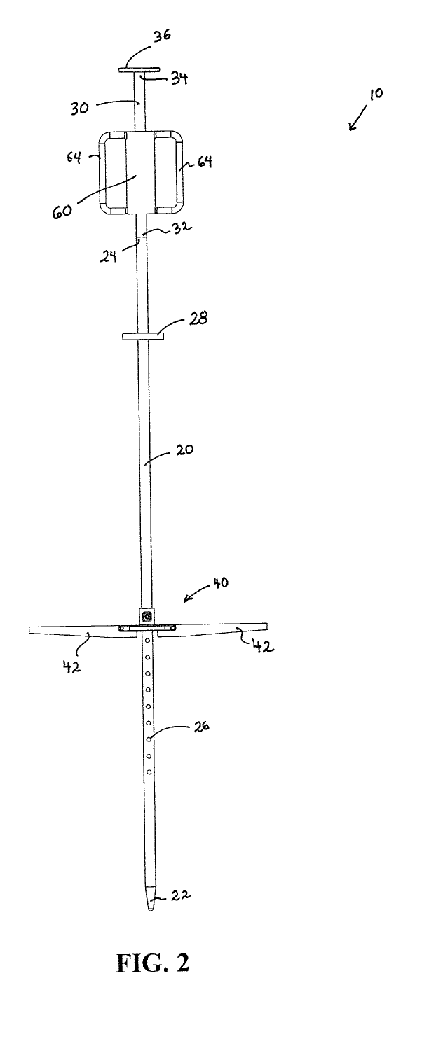

A ground penetrating tool 10 according to a preferred embodiment of the present invention will now be described in detail with reference to FIGS. 1 through 5 of the accompanying drawings. The ground penetrating tool 10 includes an elongate rod having a cylindrical configuration and including a first rod portion 20 and a second rod portion 30. The first rod portion 20 includes a pointed first end 22 that may be driven into a ground surface and an open second end 24 (FIGS. 1 and 2). Preferably, the first rod portion 20 is constructed of steel or other durable material capable of withstanding impact forces and capable of penetrating a hard ground surface.

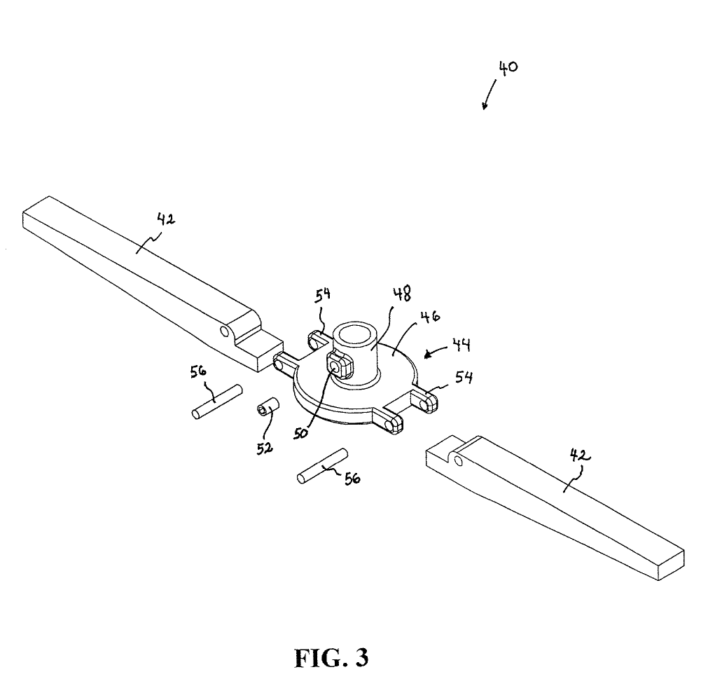

A portion of the first rod portion 20 situated between the first 22 and second 24 ends defines a plurality of apertures 26 spaced longitudinally therealong. The tool 10 includes a footrest assembly 40 having a collar 44 and a pair of footrests 42 although a single footrest would be suitable (FIG. 3). The collar 44 includes a base 46 with a tubular attachment member 48 normal thereto through which the first rod portion 20 is slidable. The tubular attachment member 48 defines an aperture 50 which may be aligned selectably with one of the plurality of apertures 26 and secured with a fastener 52 such as an Allan screw of the like. Thus, the footrest assembly 40 is height adjustable along the first rod portion 20. The base 46 includes opposed pairs of flanges 54 to which each footrest 42 is pivotally mounted with pins 56 or similar fasteners. Each footrest, therefore, is selectively movable between a first storage configuration parallel to the first rod portion (FIG. 1) and a second use configuration perpendicular to the first rod portion 20 (FIG. 2).

A striker plate 28 is fixedly attached to the first rod portion 20 between the first 22 and second 24 ends thereof and preferably between the plurality of apertures 26 and second end 24 (FIG. 2). The striker plate 28 is constructed of steel or other durable material capable of withstanding impact forces. The striker plate 28 is coupled to the first rod portion 20 in a surrounding relationship although it is not limited to a particular configuration. Preferably, the open second end 24 includes an inwardly threaded configuration.

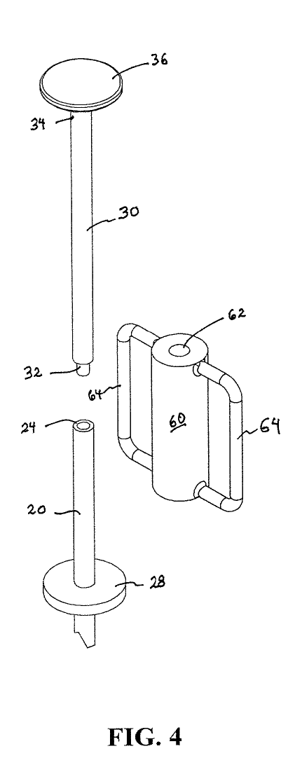

The second rod portion 30 includes a first end 32 having a threaded end capable of mating with the open second end 24 of the first rod portion 20. Obviously, other mating constructions could be used. The second rod portion 30 includes a second end 34 having a stop plate 36 fixedly attached thereto in a surrounding relationship. Therefore, the second rod portion 30 may be removed from the first rod portion 20 for convenient storage, such as in the trunk of a real estate agent's automobile. The ground penetrating tool 10 further includes a hammer sleeve 60 having a central bore 62 extending longitudinally therethrough (FIG. 4) such that the hammer sleeve 60 may be slidably coupled to the first 20 and second 30 rod portions for slidable movement between the striker 28 and stop 36 plates when the rods are coupled to one another. The hammer sleeve 60 may be removed when the second rod portion 30 is threadably removed from engagement with the first rod portion 20.

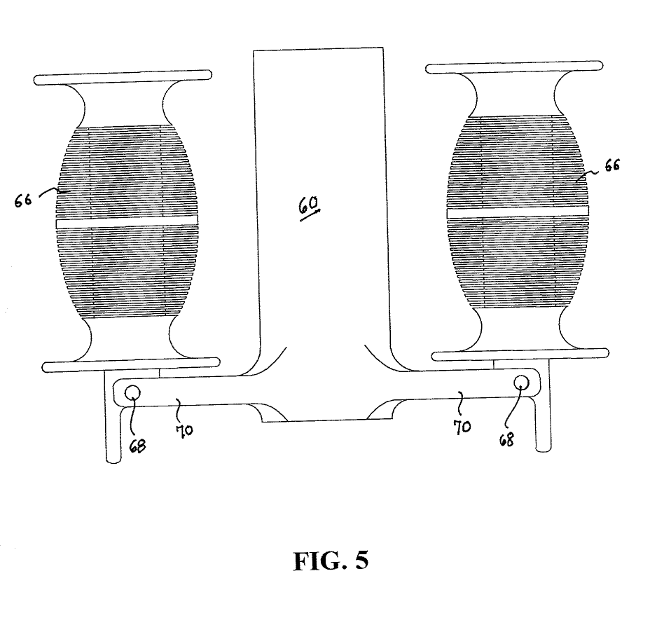

A pair of U-shaped handles 64 are fixedly attached to the hammer sleeve 60 such that the hammer sleeve 60 may be reciprocated by a user along the first 20 and second 30 rod portions between the striker 28 and stop 36 plates (FIG. 2). The hammer sleeve 60 is constructed of a heavy, durable material having upper and lower impact surfaces for direct impact with the striker 28 or stop 36 plates. Alternatively, the handles 64 may be in the form of ergonomically shaped handgrips 66 having a rubber construction which enhance a user's ability to comfortably grip and utilize the hammer sleeve 60 (FIG. 5). Each handgrip 66 may be attached with a pin 68 to a flange 70 extending from the hammer sleeve 60 adjacent the lower impact surface thereof.

In use, the ground penetrating tool 10 may be stored with the first rod portion 20 separated from the second rod portion 30. During setup, the hammer sleeve 60 may be slidably mounted to the first rod portion 20 by inserting the open second end 24 thereof through the central bore 62 of the hammer sleeve 60 (FIG. 4). By grasping the handles 64, a user may repeatedly hammer the hammer sleeve 60 against the striker plate 28 whereby to drive the pointed first end 22 of the first rod portion 20 into the ground. The footrest assembly 40 may be mounted to the first rod portion 20 at a selected aperture 26 and foot pressure may be applied to one or both footrests 42 to further urge the first end 22 into the ground. By grasping the handles 64 and repeatedly striking the stop plate 36 with the hammer sleeve 60, the first end 22 of the first rod portion 20 may be urged out of the ground. For storage, the second rod portion 30 may be threadably released from the first rod portion 20, the hammer sleeve 60 may be removed, and the footrests 42 may be pivoted to the FIG. 1 configuration.

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. A ground penetrating tool for forming a hole in a ground surface for receiving a sign post, said ground penetrating tool comprising:
an elongate cylindrical rod having a pointed first end and a second end;
a striker plate attached to said rod in surrounding relationship between said first and second ends;
a hammer sleeve coupled to said rod for slidable movement between said second end and said striker plate, said hammer sleeve having an impact surface for impacting said striker plate whereby to urge said first end into a ground surface; and
at least one footrest coupled to said rod between said first end and said striker plate adapted to receive a foot of a user thereon, whereby to urge said first end of said rod into the ground surface.

2. The ground penetrating tool as in claim 1 wherein said at least one footrest is pivotally coupled to said rod and selectively movable between a first configuration parallel to said rod and a second configuration perpendicular to said rod, said at least one footrest adapted to receive a user's foot thereon at said second configuration.

3. The ground penetrating tool as in claim 1 wherein said rod defines a plurality of apertures spaced apart longitudinally along a portion of said rod between said striker plate and said first end;
said tool further comprising means for holding said at least one footrest at a selected aperture.

4. The ground penetrating tool as in claim 1 further comprising a handle fixedly attached to said hammer sleeve for user reciprocation of said hammer sleeve.

5. The ground penetrating tool as in claim 4 wherein said handle includes a pair of handle members, each handle member defining an ergonomic configuration for gripping by a user's hand and having a rubber construction.

6. The ground penetrating tool as in claim 1 further comprising a stop fixedly attached to said second end of said rod and adapted to retain said hammer sleeve between said second end and said striker plate and adapted to be selectively impacted by said hammer sleeve so as to remove said first end of said rod from the ground surface.

7. A ground penetrating tool for forming a hole in a ground surface for receiving a sign post therein, said ground penetrating tool comprising:
a first rod portion having a pointed first end and an opposed second end;
a second rod portion having a first end releasably coupled to said second end of said first rod portion, said second rod portion having an opposed second end;
a striker plate attached to said first rod portion in a surrounding relationship and displaced from said second end thereof;
a stop plate fixedly attached to said second end of said second rod portion; and
a hammer sleeve adapted to be slidably coupled to said first and second rod portions for reciprocating movement between said striker plate and said stop plate, said hammer sleeve having a lower impact surface for impacting said striker plate whereby to urge said first end of said first rod portion into a ground surface and having an upper impact surface for impacting said stop plate whereby to remove said first end of said first rod portion from said ground surface.

8. The ground penetrating tool as in claim 7 further comprising at least one footrest coupled to said first rod portion between said first end thereof and said striker plate, said at least one footrest adapted to receive a foot of a user thereon whereby to urge said first end of said first rod portion into the ground surface.

9. The ground penetrating tool as in claim 8 wherein said at least one footrest is pivotally coupled to said first rod portion and selectively pivotal between a first configuration parallel to said first rod portion and a second configuration perpendicular to said first rod portion, said at least one footrest adapted to receive a user's foot thereon at said second configuration.

10. The ground penetrating tool as in claim 8 wherein said first rod portion defines a plurality of apertures spaced apart longitudinally between said first end of said first rod portion and said striker plate; and
said tool further comprising means for holding said at least one footrest at a selected aperture.

11. The ground penetrating tool as in claim 7 further comprising a handle fixedly attached to said hammer sleeve for user reciprocation of said hammer sleeve.

12. The ground penetrating tool as in claim 11 wherein said handle includes a pair of handle members, each handle member defining an ergonomic configuration for gripping by a user's hand and having a rubber construction.

13. A ground penetrating tool for forming a hole in a ground surface for receiving a sign post, said ground penetrating tool comprising:
a first rod portion having a pointed first end and an opposed second end;
a second rod portion having a first end releasably coupled to said second end of said first rod portion, said second rod portion having an opposed second end;
a striker plate attached to said first rod portion in a surrounding relationship and displaced from said second end thereof;
a stop plate fixedly attached to said second end of said second rod portion;
a hammer sleeve adapted to be slidably coupled to said first and second rod portions when said second rod portion is coupled to said first rod portion for reciprocating movement between said striker plate and said stop plate, said hammer sleeve having a lower impact surface for impacting said striker plate whereby to urge said first end of said first rod portion into a ground surface and having an upper impact surface for impacting said stop plate whereby to remove said first end of said first rod portion from said ground surface;
a pair of footrests coupled to said first rod portion between said first end thereof and said striker plate, said at least one foot rest adapted to receive a foot of a user thereon, whereby to urge said first end of said first rod portion into the ground surface; and
wherein each footrest is pivotally coupled to said first rod portion and selectively pivotal between a first configuration parallel to said first rod portion and a second configuration perpendicular to said first rod portion, each footrest being adapted to receive a user's foot thereon at said second configuration.

14. The ground penetrating tool as in claim 13 wherein said first rod portion defines a plurality of apertures spaced apart longitudinally between said first end of said first rod portion and said striker plate; and
said tool further comprising means for holding said pair of footrests at a selected aperture.

15. The ground penetrating tool as in claim 13 further comprising a handle fixedly attached to said hammer sleeve for user reciprocation of said hammer sleeve.

16. The ground penetrating tool as in claim 15 wherein said handle includes a pair of handle members, each handle member defining an ergonomic configuration for gripping by a user's hand and having a rubber construction.
